(19) United States
(12) Patent Application Publication
(10) Pub. No.: US 2015/0234703 A1
(43) Pub. Date: Aug. 20, 2015

(54) SYSTEM AND METHOD TO PERFORM A BACKUP OPERATION USING ONE OR MORE ATTRIBUTES OF FILES

(71) Applicant: NetApp, Inc., Sunnyvale, CA (US)

(72) Inventors: Kishore Kasi Udayashankar, San Jose, CA (US); Gokul Soundararajan, Sunnyvale, CA (US)

(73) Assignee: NetApp, Inc., Sunnyvale, CA (US)

(21) Appl. No.: 14/185,538

(22) Filed: Feb. 20, 2014

(51) Int. Cl. G06F 11/10

(52) U.S. Cl. CPC G06F 11/1004

(57) ABSTRACT

A system and method for performing a backup operation is described. A source system determines a set of files to be backed up at a backup system. Based on one or more attributes of each file of the set of files, the source system determines an order in which to perform the backup operation for the set of files. The order specifies an individual file of the set of files to be backed up before another file of the set of files. The source system communicates with the backup system to perform the backup operation of the set of files in the determined order.

### BACKGROUND

A storage system can perform a backup operation in which data stored at the storage system is backed up and stored at a backup storage system. This enables a storage system to potentially recover any lost data by retrieving a copy of the data from the backup storage system. In order to reduce the volume of data stored at the backup storage system, the backup storage system can perform data deduplication by storing only a single instance of duplicate data.

### BRIEF DESCRIPTION OF THE DRAWINGS

FIG. 1A illustrates an example system to perform a backup operation using one or more attributes of files.

FIGS. 1B and 1C illustrate example systems for coordinating backup operations.

FIG. 2 illustrates an example method for performing a backup operation using one or more attributes of files.

FIGS. 3A and 3B are example illustrations pertaining to a backup operation by a storage system.

FIG. 4 is a block diagram that illustrates a computer system upon which examples described herein may be implemented.

### DETAILED DESCRIPTION

Examples described herein provide for a storage system that specifies an order in which to perform a backup operation for a set of files. The storage system can determine the order based on one or more attributes of the files in the set of files and/or based on pre-configured rules or parameters. In some examples, by specifying the order in which to perform the backup operation, the storage system can reduce the amount of time it takes for a backup storage system to perform the backup operation, and can improve the efficiency of the data deduplication process.

According to at least some examples, a source system can determine a set of files to be backed up at a backup system. The source system can communicate with the backup system over one or more networks. The source system can determine, based on one or more attributes of each file of the set of files, an order in which to perform the backup operation for the set of files. The order can specify an individual file in the set of files to be backed up before another file in the set of files. The source system can communicate with the backup system to perform the backup operation of the set of files in the determined order.

In one example, for each file in the set of files, the source system can divide that file into a plurality of data blocks. For example, a file can be split into data blocks of 4 KB, 8 KB, 32 KB, etc. The source system can also determine, for each file in the set of files, a checksum or fingerprint for each data block of the plurality of data blocks using a checksum or fingerprint mechanism. Examples of a checksum mechanism can include a cryptographic function, such as SHA-1 or MD-5. Information about the checksum and the associated data block can be maintained in a database.

The source system can access metadata of the individual files of the set of files in order to determine one or more attributes of the files. For example, an attribute can correspond to a file type, a file size, a file create time, a file owner, or read-only status of the file. Based on one or more pre-configured rules or parameters, the source system can determine an order in which to perform the backup operation for the set of files. The source system can communicate with the backup system to transmit the checksums for each file of the set of files based on the determined order.

As used herein, a “source system” or “source storage system” can refer to a storage system that is a source of a data backup operation, and a “backup system” or “backup storage system” can refer to a storage system that is a destination or target of the data backup operation in which data from the source system is to be transferred or copied to. Although examples described herein relate to file-based storage systems that store and backup files or sets of files, in other examples, a type or class of storage systems can include an object store or an object storage system that stores data in the form of objects. An object storage system can store contents for a given key. Techniques described herein are applicable to object storage systems depending on implementation.

For example, for an object-based storage system, a storage system can perform a backup operation for a set of objects (as opposed to a set of files) in which the objects are to be backed up at a backup system. The storage system can access metadata of the individual objects of the set of objects in order to determine one or more attributes of the objects, and to determine an order in which to perform the backup operation for the set of objects. Accordingly, examples pertaining to files as described herein are also applicable to objects.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. Examples described herein may be implemented, in whole or in part, on computing devices such as servers, desktop computers, cellular or smartphones, personal digital assistants (e.g., PDAs), laptop computers, printers, digital picture frames, network equipments (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples can be carried and/or executed. In particular, the numerous machines shown with examples include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

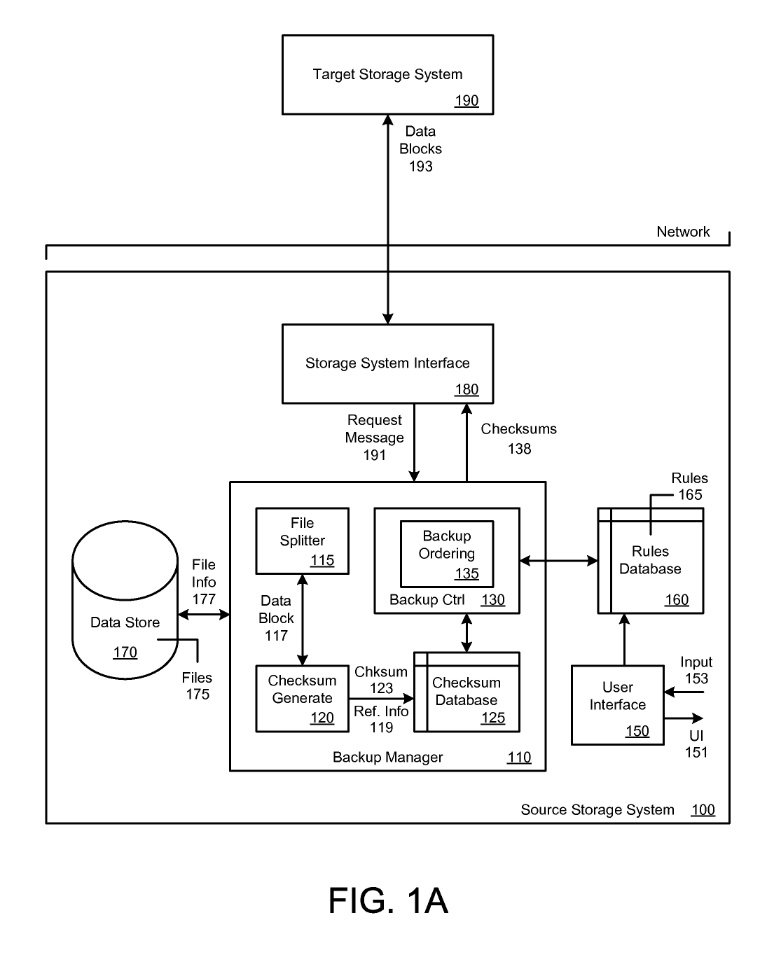

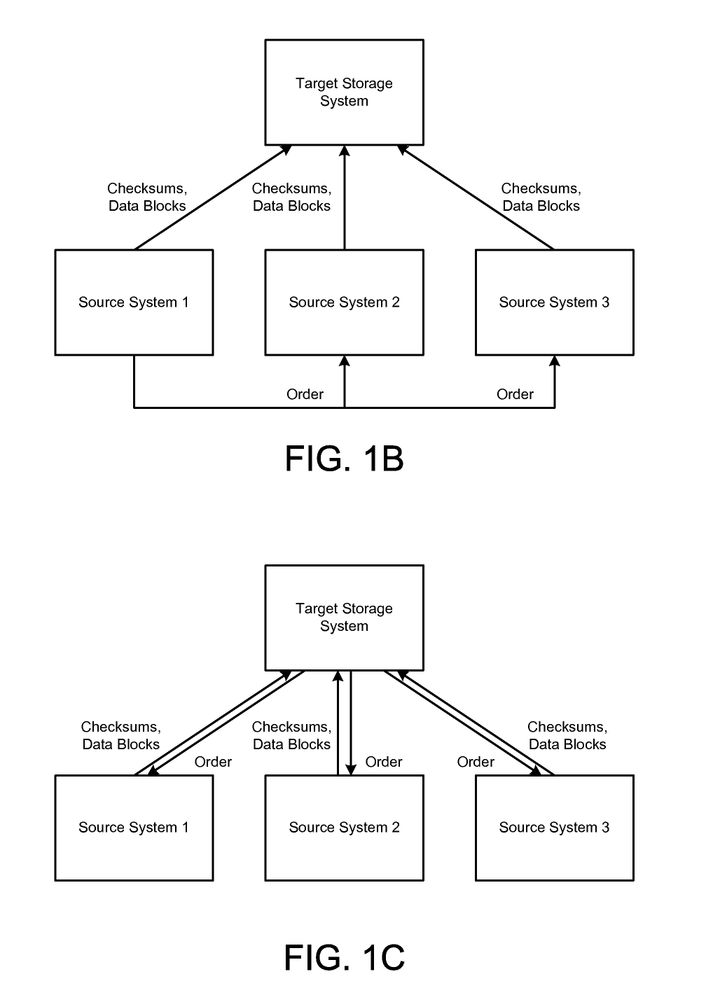

FIG. 1A illustrates an example system to perform a backup operation using one or more attributes of files. A source system can determine an order in which to perform a backup operation for a set of files based on one or more attributes of the files. The source system can access information of the files, such as the metadata of the files, for example, in order to determine the order that the files are to be backed up at a backup system. In this manner, the source system can assist in improving the data deduplication process that is performed by the backup system as part of the backup operation.

In one example, system 100, such as a source storage system, can include a backup manager 110, a user interface component 150, a rules database 160, a data store 170, and a storage system interface 180. One or more components of system 100 can be implemented on a computing device, such as a server, laptop, personal computer, etc., or on multiple computing devices that can communicate with other devices or storage systems over one or more networks. System 100 can also be implemented through other computer systems in alternative architectures (e.g., peer-to-peer networks, etc.). Logic can be implemented with various applications (e.g., software) and/or with firmware or hardware of a computer system that implements system 100.

System 100 can also communicate, over one or more networks via a network interface (e.g., wirelessly or using wired connection(s)), with one or more other storage systems, such as a target storage system 190, using a storage system interface 180. The storage system interface 180 can enable and manage communications as well as data transmissions between system 100 and the target storage system 190. In one example, the target storage system 190 can correspond to a backup storage system that backs up and stores data on behalf of system 100.

According to some examples, the backup manager 110 controls the backup operation process for system 100. The backup manager 110 can perform different operations as a part of the backup operation process and/or before, after, or during the backup operation process. In addition, when data stored at system 100 is to be backed up at a target storage system 190, the backup manager 110 can communicate with the target storage system 190 via the storage system interface 180. The backup manager 110 can enable periodic backup operations to be performed (e.g., every few days, every week, etc.) in order to back up data at the target storage system 190 based on a preconfigured schedule.

As part of a backup operation process, the backup manager 110 can perform operations for enabling data deduplication at the target storage system 190. The backup manager 110 can access the data store 170 of system 100 to determine a set of files to be backed up at the target storage system 190 (e.g., in a file-based system) or a set of objects to be backed up (e.g., in an object system). In one example, the plurality of files 175 that are stored in the data store 170 can be arranged or viewed by a user of system 100 using a file system operating on system 100. The backup manager 110 can include a file splitter 115 that splits or divides each file of the set of files (or each object of the set of objects) into a plurality of data blocks. For example, a file, such as a document or an e-mail message, can be divided into data blocks, each having a size of 4 KB. For each data block 117, a checksum generate 120 can determine a checksum or hash for that data block 117 using a checksum function or a checksum algorithm. The checksum function or algorithm can cause a data block that has different content than another data block to have different checksums. In some examples, the checksum can correspond to an identifier or key of the data block.

When data is to be backed up with the target storage system 190, for example, the backup manager 110 can provide the checksums of data blocks for a particular file (or a particular object) to the target storage system 190. For each checksum, the target storage system 190 can determine whether a corresponding data block is stored (e.g., previously received and stored) at the target storage system 190. The target storage system 190 can access its checksum database to compare the received checksum with stored checksums and determine if a match is found. If a match is found, the target storage system 190 can determine that a corresponding data block is already stored at the target storage system 190 and does not have to receive the data block from system 100. On the other hand, if a match is not found, the target storage system 190 can determine that the corresponding data block is not yet stored and requests the data block from system 100. In such an example, by dividing up a file or object into data blocks and determining the checksums for the data blocks, system 100 can enable data deduplication at the target storage system 190 as part of the backup operation process.

The checksum database of the target storage system 190 can include an extremely large number of entries for a checksum and a corresponding data block. As a result, in some examples, the lookup process performed by the target storage system 190 as part of the data deduplication process can be extremely time consuming. In addition, a typical backup operation can cause a set of files or a set of objects to be backed up in a predefined order, such as alphabetical order (based on the names of the files), or disk order, which can also cause the target storage system 190 to perform a search for a previously received data block, and then search the same data block again at a much later time. To avoid inefficient searching by the target storage system 190 for purposes of data deduplication, in one example, the backup manager 110 can determine an order in which to perform the backup operation for a set of files or a set of objects based on one or more attributes of the files or the objects.

Referring back to FIG. 1A, the file splitter 115 can divide each file of a set of files or each object of a set of objects (that are to be backed up at the target storage system 190) into a plurality of data blocks. For each data block 117 of each individual file or object, the checksum generate 120 can determine a checksum 123. The checksum generate 120 can store each checksum 123 with corresponding reference information 119 for that data block in a checksum database 125. While the checksum database 125 is illustrated as part of the backup manager 110 in the example of FIG. 1A, depending on examples, the checksum database 125 can be stored with the data store 170 or in other memory resources of system 100. In addition, although only one checksum database 125 is illustrated, multiple databases can be used by the backup manager 110. Although not illustrated in FIG. 1A, the backup manager 110 can also access and manage a file/object index or file/object database that maps each file or object and its corresponding data blocks. The target storage system 190 can also store and maintain its own file index or file database for purposes of reconstructing a file using the corresponding data blocks.

The backup manager 110 can include a backup control 130, which can access the checksum database 125 in order to transmit the checksums 138 for the set of files or set of objects to the target storage system 190 as part of the backup operation process. The backup control 130 can access rules 165 or parameters stored in the rules database 160 in order to control the backup manager 110. For example, the rules database 160 can store rules that direct or specify when the backup manager 110 is to perform a backup operation, which target storage system 190 to back up to, what files or folders/directories of files to back up, which users or groups of users' files to back up, etc. In one example, system 100 can include a user interface component 150 that can communicate with and work in conjunction with the backup manager 110. The user interface component 150 can provide user interfaces, such as a user interface 151, to be displayed on a display device, and can provide a mechanism to enable a user to provide inputs 153 for configuring the rules or parameters to operate system 100 (e.g., to control the backup manager 110). For example, the user can specify a backup schedule that is accessed by the backup control 130, so that the backup manager 110 performs a backup operation on a certain day (e.g., every few days, every weekend) and at a certain time (e.g., at 11 pm, 2 am, etc.). The user can also specify which folders or directories of files to backup by interacting with the user interface 151 and providing inputs 153.

The rules database 160 can also include rules 165 or parameters for determining an order in which to perform the backup operation for a set of files or a set of objects. The rules 165 or parameters can be predetermined or configurable by a user of system 100. A backup ordering component 135 of the backup control 130 can determine, based on one or more rules or parameters from the rules database 160, an order in which to perform the backup operation. For example, the one or more rules or parameters can direct the backup ordering component 135 to arrange a set of files or a set of objects that are to be backed up in an order based on one or more attributes, such as (i) file/object type or file extension, (ii) file or object size, (iii) create time, (iv) owner or creator, (v) read-only status (whether a file or object is read-only or not), (vi) executable-status (whether a file or object is executable or not), or (vii) other metadata. The rule(s) can specify that a first attribute is used to sort or group the files or objects initially, then a second attribute is used to sort within the group, and then a third attribute is used, and so on.

The backup ordering component 135 can access file/object information 177 (or metadata) of the set of files or the set of objects that are to be backed up, and based on the rule(s), order the files or objects accordingly. The file/object information 177 can include information about attributes or properties of the files or objects, such as file/object type, program information that can run or open the file or object, location in the file system or object store, size, create time or date, most recent modified time or date, most recent accessed time or date, read-only status, executable-status, user accessibility information, etc. The backup ordering component 135 can determine the various file attributes from the file information 177.

For example, a set of files, File A, File B, File C, File D, and File E, are to be backed up to the target storage system 190. File A can be 500 KB in size and File D can be 200 KB in size and File A and File D can be a .doc file. File C can be 200 KB in size and be an .xls file. File B can be 400 KB in size and File E can be 600 KB in size and both can be a .pdf file. The rule(s) can specify that .pdf files are to be backed up first, then .doc files, then .xls files, etc., and that after the initial grouping, sorting, or ordering of the files, file size is to be used to further order the files (e.g., larger files are to be backed up before smaller files within those groups). Based on the attributes of the set of files determined from the file information 177 (e.g., metadata) and based on the rule(s), the backup ordering component 135 can determine a specific order in which the set of files are to be backed up: File E, File B, File A, File D, File C.

The backup control 130 can cause the set of files or set of objects to be backed up in the determined order. For example, the backup manager 110 can communicate with the target storage system 190 to perform the backup operation of the files by transmitting checksums 138 in sequence based on the determined order. Referring to the example, in this manner, the checksums corresponding to data blocks of the first file, File E, are transmitted, the checksums corresponding to data blocks of the second file, File B, are transmitted, the checksums corresponding to data blocks of the third file, File A, are transmitted, and so on, in the specified order of the files.

When the target storage system 190 receives a checksum, the target storage system 190 can determine whether the corresponding data block of that checksum is stored at the target storage system 190 (as a result of a previous backup operation). If the target storage system 190 determines that the corresponding data block has been previously received (e.g., a stored checksum matches the received checksum), then the target storage system 190 provides a message to the backup manager 110 indicating that the data block has already been received. The backup manager 110 can then transmit the next checksum to the target storage system 190 based on the order. If the target storage system 190 determines that the corresponding data block has not been received (e.g., no stored checksum matches the received checksum), then the target storage system 190 provides a request message 191 to the backup manager 110 asking for the corresponding data block. The backup manager 110 can then transmit the appropriate data block 193 to the target storage system 190, and then transmit the next checksum to the target storage system 190 based on the order. The process can continue until the set of files have been backed up and the backup operation is completed.

By enabling system 100 to determine an order in which to perform the backup operations for a set of files, system 100 can improve the efficiency of the backup operation, and in particular, the data deduplication process. For example, data blocks having the same checksums are typically found to have similar metadata values or attributes, such as the same file type and/or similar create time and/or owner. Grouping files that are of the same file type and causing those files to be backed up around a similar time (e.g., back up those files before backing up another type of files) can enable the target storage system 190 to more quickly find matching checksums as compared to a typical backup operation using an alphabetical order or disk order in which the target storage system 190 would perform a search for a previously received data block, and then search the same data block again at a much later time. In some examples, system 100 coordinate backup operations between system 100 and one or more other source storage systems with the target storage system 190 using a determined order.

FIGS. 1B and 1C illustrate example systems for coordinating backup operations. For example, FIGS. 1B and 1C illustrate three source systems and a target storage system. Depending on examples, any one or more of the source systems or target storage system can implement system 100, such as described in FIG. 1A. Although only three source systems and only one target storage system are illustrated in FIGS. 1B and 1C, in other examples, less than three or more than three source systems and more than one target storage system can be included in the system.

In FIG. 1B, three source systems can communicate with a target storage system to each perform a backup operation in which data/files of the respective source system are backed up at the target storage system. One of the three source systems can determine an order in which to perform a backup operation and coordinate with the other two source systems. For example, source system 1 can implement system 100 of FIG. 1 to determine, based on one or more attributes of a set of files that are to be backed up, an order in which to perform the backup operation. Source system 1 can provide information about the determined order to the other source systems. The information about the determined order can indicate to the other source systems that source system 1 will back up its set of files in a specific order to the target storage system. The other source systems can use this information to coordinate their backup operations to also perform the backup operation for their respective files based on the determined order.

Each of the source systems can then transmit the checksums and/or the data blocks in a sequence based on the determined order. According to some examples, the source systems can also communicate with each other during the backup operation processes to notify each other when a particular group of files are done backing up so that the next group of files. For example, if the order specified that .doc files are to be backed up first and then .pdf files, each source system can notify the other when it has completed backing up the respective .doc files. Once each source system indicates to the others that the backup operation of .doc files have been completed, the source systems can then begin the backup operations of .pdf files.

In some examples, another device, such as an external controller (or the target storage system itself) can control the coordination of backup operations between the source systems. The external controller (e.g., external to the source systems) can determine the order in which files are to be backed up, and can communicate with the individual source systems to instruct or trigger the source systems to transmit checksums and/or data blocks in the determined order. The external controller can continually monitor the backup operations of each of the source systems and can also instruct the order in which the source systems perform the backup operations. For example, the external controller can cause source system 1 to first perform backup operations of .doc files, then cause source system 2 to perform backup operations of .doc files, then cause source system 3 to perform backup operations of .doc files, and then cause source system 1 to perform backup operations of .pdf files, and so forth.

In one example, such as illustrated in FIG. 1C, the target storage system can control the coordination of backup operations of the source systems. The target storage system can implement system 100 of FIG. 1A, for example, in order to determine an order in which it wants to receive files from the source systems. The target storage system can provide information about the order in which it wants to receive the files to each of the source systems. For example, the target storage system can notify each source system that it will be receiving .xls files first, then .doc files, then .log files, etc., or that it will be receiving files greater than a particular size first, then files within a first specified range of sizes, then files within a second specified range of sizes, etc. The target storage system can also control which source systems will provide checksums first (e.g., instruct source system 2 to first transmit files having a first attribute, then instruct source system 1 to transmit files having the first attribute, then instruct source system 3 to transmit files having the first attribute).

According to some examples, multiple target storage systems (e.g., multiple individual backup servers) can communicate with each other for purposes of backup and data deduplication efficiency. The target storage systems can communicate, amongst each other, information about a determined order in which files from a source system(s) are to be backed up. Depending on implementation, the target storage systems can coordinate, amongst each other, which files (based on one or more attributes) are to be received by individual target storage systems. In other examples, an external controller can coordinate backup streams (e.g., checksums and/or data blocks for specific files) from the source systems to be directed to individual target storage systems. For example, if three target storage systems are coordinated, target system 1 can be designated to back up files having a first attribute (e.g., a first file type, a first file size range, or a first owner or creator, etc.), while target system 2 can be designated to back up files having a second attribute (e.g., a second file type, a second file size range, or a second owner or creator, etc.) and target system 3 can be designated to back up files having a third attribute. In this manner, a target storage system can have a greater likelihood of finding a matching data block (using checksums) by receiving files of a particular attribute.

Methodology

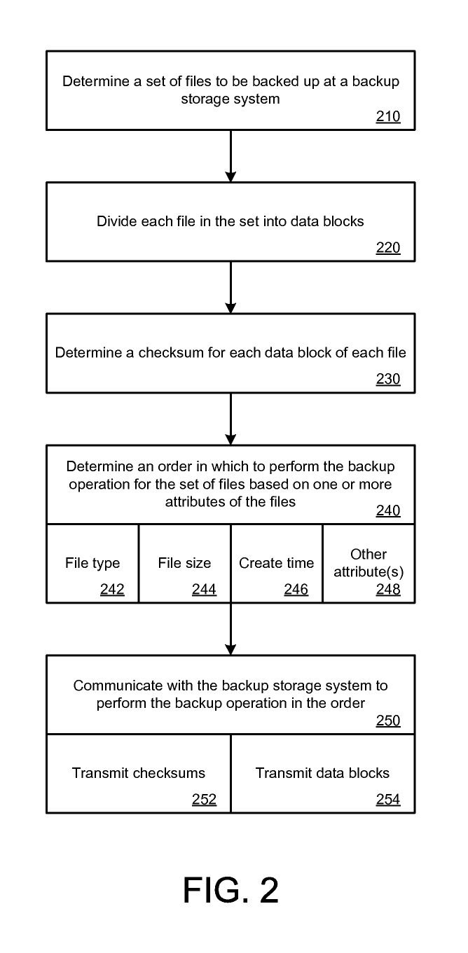

FIG. 2 illustrates an example method for performing a backup operation using one or more attributes of files. A method such as described by an example of FIG. 2 can be implemented using, for example, components described with examples of FIGS. 1A through 1C. Accordingly, references made to elements of FIGS. 1A through 1C are for purposes of illustrating a suitable element or component for performing a step or sub-step being described.

A source storage system 100 can communicate with a backup storage system 190 in order to backup files of the source storage system 100 at the backup storage system 190. Referring to FIG. 2, the source storage system 100 can determine, for a backup operation that is to be performed, a set of files that are to be backed up at the backup storage system 190 (210). The set of files can correspond to files of one or more folders or directories in a file system operated on the source storage system 100. In some examples, the source storage system 100 can perform periodic backup operations, based on a schedule, in which files stored at the source storage system 100 can be periodically backed up at the backup storage system 190.

For each file of the set of files, the source storage system 100 can divide the file into a plurality of data blocks (220). In some examples, if the file is small enough, only one data block is necessary and the source storage system 100 does not have to divide that file. The source storage system 100 can maintain a mapping database that maps a file with the data blocks for that file. For each data block, the source storage system 100 can also determine or generate a checksum for the data block (230). A checksum can identify the corresponding data block. The source storage system 100 can maintain a checksum database 125 that maps a checksum with a corresponding data block.

According to some examples, the source storage system 100 can determine an order in which to perform a backup operation for the set of files based one or more attributes of the files in the set of files (240). For example, the source storage system 100 can access metadata of the files in the set of files to determine the attributes of the files. Based on one or more predefined or user-configured rules or parameters, the source storage system 100 can use one or more of the attributes to specify an order for which the files are to be backed up at the backup storage system 190. Depending on implementation, the order can be based on one or more attributes, such as a file type or extension (242), a file size (244), a create or modify time (246), and/or other attributes (248).

For example, the order can be determined by grouping the set of files into a plurality of groups, where each group corresponds to an attribute, such as file type. The groups can be ordered or ranked, for example, from one to twenty (if there are twenty file type groups, for example), with one being designated as a group of files that are to be backed up first. Within each group, a second ordering and/or grouping can be performed based on another different attribute, such as owner or create time, and so forth. The ordering can be based on the specified rule(s) configured for the source storage system 100. While the example describes first ordering the files by groups based on file types, other examples include first ordering the files by another attribute, such as grouping the set of files into a plurality of groups based on file size, create time, owner, or whether the files are read-only or not.

The source storage system 100 can communicate with the backup storage system 190 to perform the backup operation of the set of files based on the determined order (250). For example, the order can specify that files having a first owner or creator (e.g., a user in a network with multiple users) is to be backed up first, and then the second owner, etc. The source storage system 190 can transmit checksums corresponding to the file(s) in succession to the backup storage system 190 in the determined order (252). A first checksum can be transmitted to the backup storage system 190, the backup storage system 190 can perform a lookup of the checksum to see if a match is found. If a match is found, the backup storage system 190 can determine that the corresponding data block of that checksum is already stored at the backup storage system 190. The backup storage system 190 can then transmit a status message to the source storage system 100 that the data block for the checksum is already received and to transmit the next checksum in the order. The source storage system 100 can transmit the next checksum.

On the other hand, if no match is found, the backup storage system 190 can transmit a request message to the source storage system 100, indicating that the data block has not been received and requesting the source storage system 100 to transmit the corresponding data block for backup (254). Once the data block has been received by the backup storage system 190, the source storage system 100 can transmit the next checksum. In this manner, the transmitting of checksums, the receiving of messages, and the transmitting of data blocks (if necessary), are performed based on the determined order for the backup operation.

While the example method of FIG. 2 is described with respect to a file-based system, the example method of FIG. 2 is also applicable to objects and object storage systems.

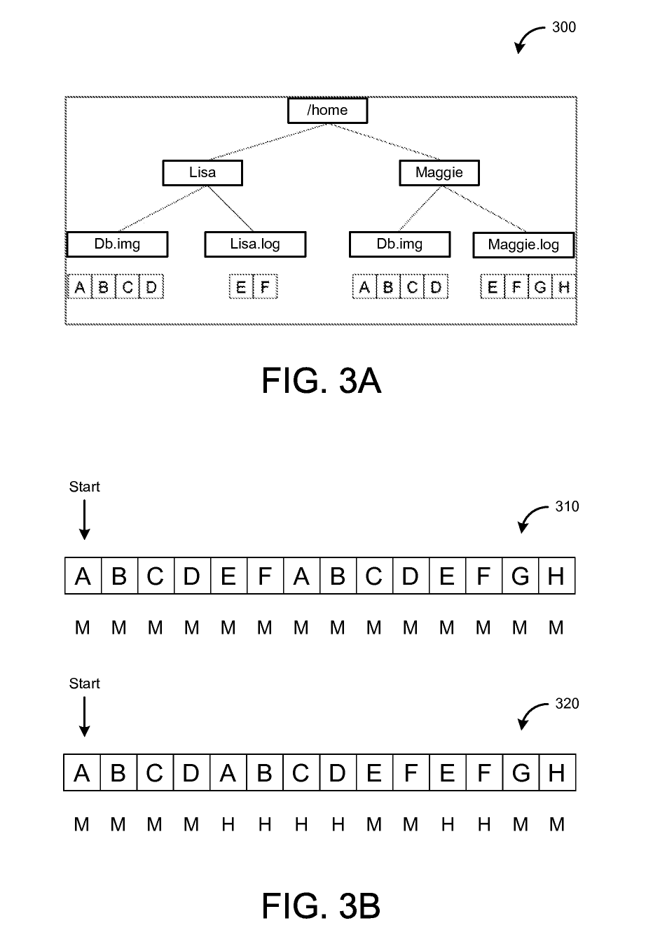

FIGS. 3A and 3B are example illustrations pertaining to a backup operation by a storage system. FIG. 3A illustrates a directory tree 300 for purposes of describing a backup operation, and FIG. 3B illustrates a diagram 310 showing a typical order, such as a disk order, and a diagram 320 showing an order determined by a source storage system implementing system 100 of FIG. 1A.

In FIG. 3A, the directory tree 300 beginning with “/home” has two sub-trees for two users, “Lisa” and “Maggie.” In the example described, each user has an .img file and a .log file. For simplicity of describing the backup operation, only four files are shown. Note that other files, and other users and sub-trees can be included, but are not shown for illustrative purposes. A source storage system can perform a backup operation to back up a set of files, such as the files in the directory beginning with “/home,” at a backup storage system. The source storage system can divide each file into a plurality of data blocks and generate/determine a checksum for each data block. In this example, Lisa's file Db.img and Maggie's file DB.img are identical—the .img files are divided into four data blocks, with a first data block having a checksum A, a second data block having a checksum B, a third data block having a checksum C, and a fourth data block having a checksum D. The files Lisa.log and Maggie.log, however, are different, but also have data blocks that are identical. Lisa.log is divided into two data blocks, with a first data block having a checksum E and a second data block having a checksum F. Maggie.log is divided into four data blocks, with the first and second data blocks being identical to the first and second data blocks of Lisa.log, a third data block having a checksum G, and a fourth data block having a checksum H.

The backup storage system can back up files from the source storage system and perform a data deduplication process as part of the backup operation. Because the backup storage system can store a large number of checksums and associated data block information, the checksum database can be extremely large. Accordingly, the checksum database can be stored in a memory resource having a large storage capacity, such as a hard drive or disk. The backup storage system can access the memory resource to perform a search of the checksum database when a checksum is received from the source storage system. However, access the memory resource to access the checksum database can be much slower, so the backup storage system can also use a checksum cache in another memory that is faster to access. Accessing the checksum cache to determine whether a received checksum matches a stored checksum is much faster and more efficient for the backup storage system.

For illustrative purposes, it is assumed that the checksum cache that the backup storage system operates in the example described with FIGS. 3A and 3B is a four entry least recently used (LRU) checksum cache. Depending on implementation, other replacement policies for a checksum cache can be used, such as a first-in-first-out (FIFO) checksum cache, least frequently used (LFU) checksum cache, etc. The LRU checksum cache discards the least recently used items in the cache first. Typically, as shown in the diagram 310 of FIG. 3B, the backup storage system can receive checksums for data blocks in solely a directory, alphabetical, or disk order. As a result, the backup storage system processes Lisa's Db.img file first, followed by Lisa.log second, then Maggie's Db.img file and then Maggie.log. Accordingly, as illustrated in the diagram 310 of FIG. 3B, backup storage system first receives the checksum A (corresponding to the first data block of Lisa's Db.img). The backup storage system can first search the checksum cache for the received checksum A. Assuming that the four entry LRU checksum cache is initially empty, no match is found in the checksum cache (e.g., “M” for miss). The backup storage system will then access and search the checksum database stored at the larger-capacity memory.

The next checksum the backup storage system receives is checksum B (corresponding to the second data block of Lisa's Db.img). Again, the backup storage system first searches the checksum cache for the received checksum B. At this point, the checksum cache has one entry with the checksum A, but again, no match is found in the checksum cache. The next checksum C is a miss as no matching checksum is found in the checksum cache, and similarly, the next checksum D is also a miss. In the typical disk order, for example, the backup storage system now receives a checksum E for the next file, Lisa.log. The checksum cache has four entries with checksums A, B, C, D, having received those checksums previously from the source storage system. However, when checksum E is received, again no match is found in the checksum cache (another “M,” for miss). Similarly, checksum F is also a miss.

As of this point, the checksum cache has four entries for checksums C, D, E, and F (as a result of the LRU, checksums A and B were discarded from the checksum cache when checksums E and F, respectively were received). The backup storage system now receives the checksum of the next file, e.g., Maggie's Db.img, from the source storage system. Although both Lisa's Db.img and Maggie's Db.img files contain the same data, the directory or disk scan order results in poor temporal locality. Checksum A is received again corresponding to the first data block of Maggie's Db.img, but again is not found in the checksum cache (another miss). Similarly, checksums B, C, and D are all misses as the checksum cache updates its entries. The result of the typical disk order backup operation or data deduplication process causes the backup storage system to continuously access the checksum database from memory, which is more inefficient and takes a longer time to find a checksum match as compared to accessing and finding a match in the checksum cache.

In contrast, when the source storage system determines, based on one or more attributes, a specific order in which the set of files are to be backed up to the backup storage system, the time it takes for the backup storage system to perform deduplication can be reduced. For example, the source storage system can order the files to be backed up based on the file type or extension, and then based on alphabetical order, such as .img files are backed up before .log files. In the example shown in diagram 320 of FIG. 3B, the backup storage system receives checksum A (corresponding to the first data block of Lisa's Db.img), checks the initially empty checksum cache, and determines a miss, “M.” Similarly, checksums B, C, and D are also received (corresponding to data blocks of Lisa's Db.img) and are also misses. The backup storage system has to access the memory to search the checksum database for each of those checksums.

However, because of the specified order, the backup storage system now receives checksums corresponding to data blocks of Maggie's Db.img. The backup storage system receives checksum A (corresponding to the first data block of Maggie's Db.img), checks the checksum cache, and determines a match (e.g., “H” for hit). The backup storage system does not have to access the memory to search the checksum database, thereby speeding up the deduplication process. The backup storage system can indicate to the source storage system that the data block corresponding to checksum A has been received and to send the next checksum. Checksum B is received next, and again, the backup storage system determines a match. After checksums for .img files are completed, the next files, e.g., the .log files can then be processed. The backup storage system receives checksums E and F corresponding to data blocks of Lisa.log, determines misses, and then accesses the memory to search the checksum database. The next file corresponds to Maggie.log, and the backup storage system determines hits for checksums E and F. In this manner, by determining an order in which files can be grouped, sequenced, ranked, etc., the amount of time it takes for a backup operation can be reduced.

Hardware Diagram

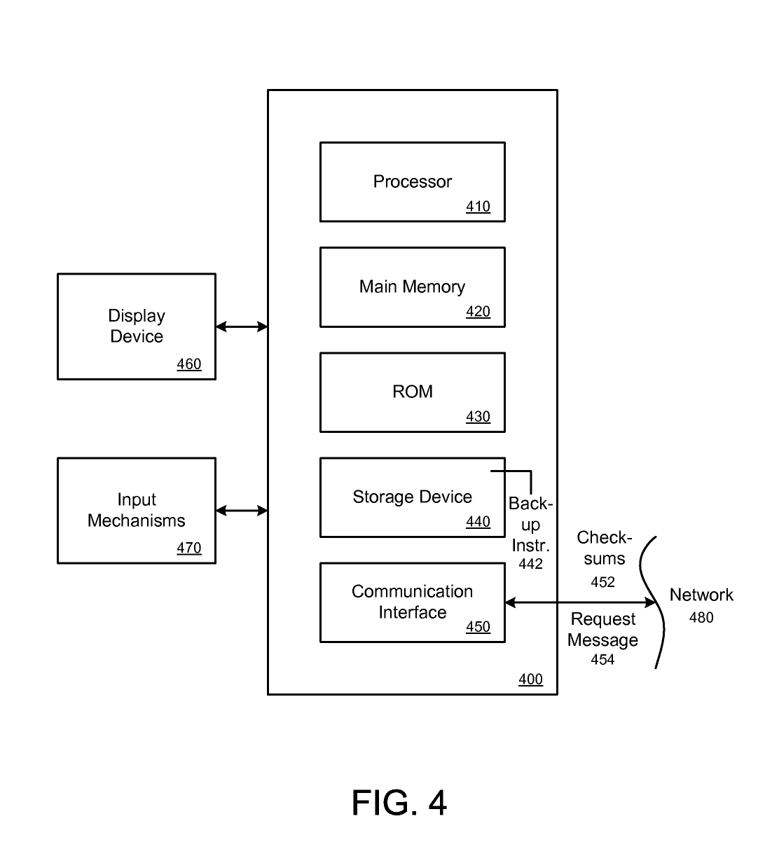

FIG. 4 is a block diagram that illustrates a computer system upon which examples described herein may be implemented. For example, in the context of FIG. 1A, system 100 may be implemented using a computer system such as described by FIG. 4. System 100 may also be implemented using a combination of multiple computer systems as described by FIG. 4.

In one implementation, computer system 400 includes processing resources 410, main memory 420, ROM 430, storage device 440, and communication interface 450. Computer system 400 includes at least one processor 410 for processing information and a main memory 420, such as a random access memory (RAM) or other dynamic storage device, for storing information and instructions to be executed by the processor 410. Main memory 420 also may be used for storing temporary variables or other intermediate information during execution of instructions to be executed by processor 410. Computer system 400 may also include a read only memory (ROM) 430 or other static storage device for storing static information and instructions for processor 410.

A storage device 440, such as a magnetic disk or optical disk, is provided for storing information and instructions. For example, the storage device 440 can correspond to a computer-readable medium that stores backup operation instructions 442 that, when executed by processor 410, may cause computer system 400 to perform operations described below and/or described above with respect to FIGS. 1 through 3 (e.g., operations of system 100 described above). In one example, the backup operation instructions 442 can cause computer system 400 to determine an order in which to perform a backup operation of a set of files based on an attribute(s) of the files in the set of files.

The communication interface 450 can enable computer system 400 to communicate with one or more networks 480 (e.g., computer network, cellular network, etc.) through use of the network link (wireless or wireline). Using the network link, computer system 400 can communicate with a plurality of systems, such as other data storage systems, including a backup system (not shown in the example of FIG. 4). In one example, computer system 400 can transmit, as part of performing a backup operation, checksums 452 of data blocks of individual files in a specified order to the backup system. Computer system 400 can receive a request message 454 from the backup system via the network link when the backup system determines that a data block corresponding to a received checksum is not previously stored at the backup system. Computer system 400 can provide the request data block to the backup system.

Computer system 400 can also include a display device 460, such as a cathode ray tube (CRT), an LCD monitor, or a television set, for example, for displaying graphics and information to a user. An input mechanism 470, such as a keyboard that includes alphanumeric keys and other keys, can be coupled to computer system 400 for communicating information and command selections to processor 410. Other non-limiting, illustrative examples of input mechanisms 470 include a mouse, a trackball, touch-sensitive screen, or cursor direction keys for communicating direction information and command selections to processor 410 and for controlling cursor movement on display 460.

Examples described herein are related to the use of computer system 400 for implementing the techniques described herein. According to one example, those techniques are performed by computer system 400 in response to processor 410 executing one or more sequences of one or more instructions contained in main memory 420. Such instructions may be read into main memory 420 from another machine-readable medium, such as storage device 440. Execution of the sequences of instructions contained in main memory 420 causes processor 410 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is being claimed is:

1. A method for performing a backup operation, the method being performed by a source system and comprising:
determining, at the source system, a set of files to be backed up at a backup system, wherein the source system can communicate with the backup system over one or more networks;
based on one or more attributes of each file of the set of files, determining an order in which to perform the backup operation for the set of files, wherein the order specifies an individual file of the set of files to be backed up before another file of the set of files; and
communicating with the backup system to perform the backup operation of the set of files in the determined order.

2. The method of claim 1, further comprising:
for each file in the set of files, (i) dividing that file into a plurality of data blocks, and (ii) determining a checksum for each data block of the plurality of data blocks using a checksum mechanism.

3. The method of claim 2, wherein communicating with the backup system includes:
transmitting, based on the determined order, each checksum for each file of the set of files to the backup system;
receiving, from the backup system, a request for a particular data block of a file when the backup system determines that the particular data block has not been previously stored in the backup system; and
transmitting the requested particular data block to the backup system.

4. The method of claim 1, wherein determining an order in which to perform the backup operation is also based on a pre-configured parameter.

5. The method of claim 1, wherein the one or more attributes includes at least one of (i) a file type, (ii) a file size, (iii) a file create time, (iv) a file owner, or (v) read-only status.

6. The method of claim 5, wherein determining an order in which to perform the backup operation includes (i) grouping the set of files into one or more groups based on the a first attribute of the one or more attributes of each file of the set of files, then (ii) ordering one or more files within the one or more groups based on a different attribute.

7. The method of claim 1, further comprising:
communicating information about the determined order to a second source system, wherein the second source system is to perform a backup operation of a set of files stored at the second source system using the information about the determined order, so that the set of files stored at the second source system is backed up at the backup system.

8. A non-transitory computer-readable medium storing instructions that, when executed by a processor of a source system, cause the processor to perform operations comprising:
determining, at the source system, a set of files to be backed up at a backup system, wherein the source system can communicate with the backup system over one or more networks;
based on one or more attributes of each file of the set of files, determining an order in which to perform a backup operation for the set of files, wherein the order specifies an individual file of the set of files to be backed up before another file of the set of files; and
communicating with the backup system to perform the backup operation of the set of files in the determined order.

9. The non-transitory computer-readable medium of claim 8, wherein the instructions further cause the processor to perform operations comprising:
for each file in the set of files, (i) dividing that file into a plurality of data blocks, and (ii) determining a checksum for each data block of the plurality of data blocks using a checksum mechanism.

10. The non-transitory computer-readable medium of claim 9, wherein the instructions further cause the processor to communicate with the backup system by:
transmitting, based on the determined order, each checksum for each file of the set of files to the backup system;
receiving, from the backup system, a request for a particular data block of a file when the backup system determines that the particular data block has not been previously stored in the backup system; and
transmitting the requested particular data block to the backup system.

11. The non-transitory computer-readable medium of claim 8, wherein the instructions further cause the processor to determine the order in which to perform the backup operation based on a pre-configured parameter.

12. The non-transitory computer-readable medium of claim 8, wherein the one or more attributes includes at least one of (i) a file type, (ii) a file size, (iii) a file create time, (iv) a file owner, or (v) read-only status.

13. The non-transitory computer-readable medium of claim 12, wherein the instructions further cause the processor to determine the order in which to perform the backup operation by (i) grouping the set of files into one or more groups based on the a first attribute of the one or more attributes of each file of the set of files, then (ii) ordering one or more files within the one or more groups based on a different attribute.

14. The non-transitory computer-readable medium of claim 8, wherein the instructions further cause the processor to perform operations comprising:
communicating information about the determined order to a second source system, wherein the second source system is to perform a backup operation of a set of files stored at the second source system using the information about the determined order, so that the set of files stored at the second source system is backed up at the backup system.

15. A backup system comprising:
a network interface;
a memory resource storing instructions; and
at least one processor coupled to the network interface and the memory resource, the at least one processor executing the instructions to perform operations comprising:
receiving, from one or more source systems, information about a set of files to be backed up at the backup system, wherein the backup system can communicate with the one or more source systems over one or more networks;
based on one or more attributes of each file of the set of files, determining, at the backup system, an order in which to perform a backup operation for the set of files, wherein the order specifies an individual file of the set of files to be backed up before another file of the set of files; and
communicating the determined order to the one or more source systems to perform the backup operation of the set of files in the determined order.

16. The storage system of claim 15, wherein the instructions further cause the at least one processor to perform operations comprising:
receiving, based on the determined order, each checksum for each file of the set of files from the one or more source systems.

17. The storage system of claim 16, wherein the instructions further cause the at least one processor to perform operations comprising:
for each received checksum, performing a search by (i) first accessing, at the backup system, a checksum cache, and (ii) in response to that checksum not being found in the checksum cache, accessing a memory resource that stores a checksum database.

18. The storage system of claim 15, wherein the instructions further cause the at least one processor to determine the order in which to perform the backup operation based on a pre-configured user-specified parameter.

19. The storage system of claim 15, wherein the one or more attributes includes at least one of (i) a file type, (ii) a file size, (iii) a file create time, (iv) a file owner, or (v) read-only status.

20. The storage system of claim 19, wherein the instructions further cause the at least one processor to determine the order in which to perform the backup operation by (i) grouping the set of files into one or more groups based on the a first attribute of the one or more attributes of each file of the set of files, then (ii) ordering one or more files within the one or more groups based on a different attribute.
